(19) United States
(12) Patent Application Publication
(10) Pub. No.: US 2026/0127197 A1
(43) Pub. Date: May 7, 2026

(54) Adaptive Confidentiality-Managed Multi-LLM System (ACMMS)

(71) Applicants: Nour Rahhal, Aliso Viejo, CA (US); Amjad Rahhal, Lake Forest, CA (US)

(72) Inventors: Nour Rahhal, Aliso Viejo, CA (US); Amjad Rahhal, Lake Forest, CA (US)

(21) Appl. No.: 18/936,962

(22) Filed: Nov. 4, 2024

(51) Int. Cl. G06F 16/332; G06F 16/353

(52) U.S. Cl. CPC G06F 16/3326; G06F 16/353

(57) ABSTRACT

The ACMMS enables a flexible, secure, confidentiality and adaptive management system across multiple LLMs, incorporating data classification, abstraction adaptive routing and feedback for continuous learning. The system utilizes abstraction, feedback mechanisms, and varied routing configurations to ensure secure, confidential and efficient LLM usage. ACMMS supports multiple embodiments, providing a versatile framework adaptable to different security and operational requirements.

### BACKGROUND OF THE INVENTION

This section addresses the challenge faced by enterprises in protecting their data privacy and intellectual property while leveraging the insights and capabilities of public LLMs. Enterprises often avoid public domain LLMs to prevent exposing proprietary information, yet they also risk losing the benefits of broader knowledge that public models offer. This invention provides a solution that allows enterprises to maintain strict control over sensitive data within private domains, while selectively utilizing the expertise and resources of public LLMs to enhance overall outcomes.

### FIELD OF THE INVENTION

This invention pertains to adaptive confidentiality management in multi-LLM systems, with a specific focus on secure data classification and routing mechanisms. This is in the field of artificial intelligence and natural language processing, specifically systems and methods for securely interacting with multiple language models (LLMs) in data-sensitive environments.

### DESCRIPTION OF RELATED ART

While public LLMs offered by cloud providers deliver expansive knowledge, they pose potential risks to data privacy when handling confidential information. The existing multi-LLM systems lack mechanisms for secure and adaptive data classifications, which are critical for protecting sensitive information. Private LLMs can be customized for secure data handling but may not provide the breadth of public models. Current solutions do not sufficiently address the need for a system that manages confidential and non-confidential data interactions between private and public LLMs while maintaining security. Our invention improves these systems by introducing confidentiality management that utilizes different LLMs (private and public) via an abstraction layer and adapts based on feedback.

### SUMMARY OF THE INVENTION

The Adaptive Confidentiality-Managed Multi-LLM System (ACMMS) enables secure interactions with multiple LLMs by utilizing a data classification framework that determines data sensitivity before selectively engaging public and private models. The adaptive confidentiality-managed multi-LLM system dynamically classifies data and routes based on defined security policies. The system features data classification, adaptive routing, abstraction layers for confidential information, adaptive routing components, and feedback mechanisms to enhance knowledge integration. This invention supports various configurations and methods for classifying data, routing queries, and reintegrating public LLM responses into the private system. By emphasizing confidentiality management, ACMMS provides flexible, secure sensitive data, and robust solutions for secure multi-LLM usage.

### BRIEF DESCRIPTION OF THE DRAWINGS

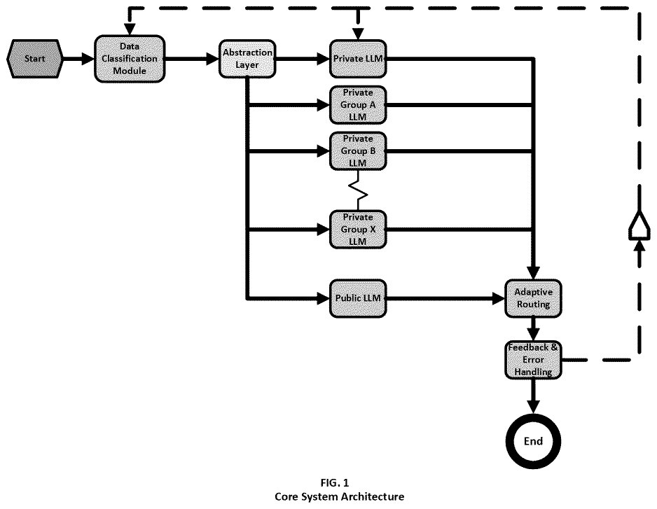

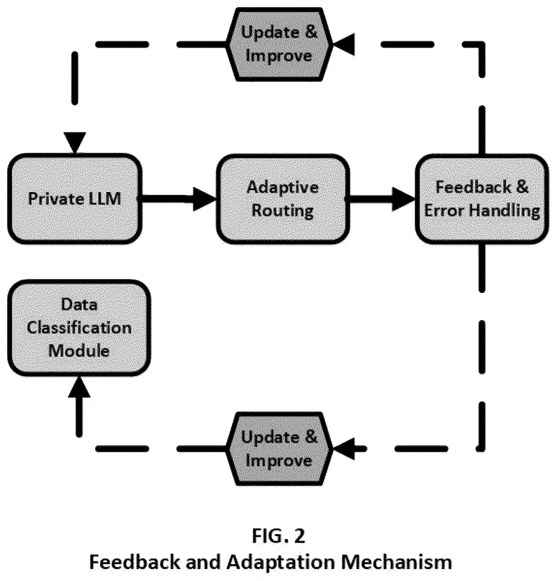

Figures depict the general architecture of the multi-LLM system. FIG. 1 illustrates the core system architecture with main components (Data Classification Module, Abstraction Layers, Private and Public LLMs, Adaptive Routing, and Feedback Integration Module), while FIG. 2 highlights the feedback and adaptation mechanism enabling continuous learning.

### DETAILED DESCRIPTION OF THE INVENTION

### Overview

The ACMMS provides a framework for multi-LLM interaction, leveraging data classification to manage confidentiality. The system can adapt to various configurations based on security requirements and allows for both sequential and parallel LLM processing to optimize performance and feedback model to enhance the knowledge and experience of the Private LLM.

The Data Classification Module dynamically assigns security levels to incoming data, informing routing decisions. The Abstraction Layer applies transformations to anonymize data, and Adaptive Routing ensures that data reaches suitable LLMs. Feedback and Error Handling provides insights to adjust future routing decisions and feedback models to teach Private LLM.

### System Components

The system includes several critical modules designed to ensure confidentiality and optimize routing. The Data Classification Module, Abstraction Layer, and Adaptive Routing framework work together to achieve secure, scalable multi-LLM interactions.

The Data Classification Module provides a robust framework for assessing data sensitivity in real-time. It assigns security levels to data, informing the Adaptive Routing framework of how best to handle the data.

The Private LLMs handles classified data and determines abstraction needed before interfacing with public or other group LLMs.

The Abstraction Layer generalizes confidential and sensitive data to minimize risk exposure. The Abstraction Layer abstracts key details from sensitive data before sending it to public LLMs. It uses data masking and anonymization techniques to protect critical information while maintaining its utility.

The Adaptive Routing Framework uses the information from the Data Classification Module to direct data to the appropriate LLMs, allowing sequential or parallel processing among multiple LLMs, based on classifications. The framework can handle multiple LLMs, applying different strategies for private and public model interaction.

The Feedback and Error Handling module is designed to continuously improve both the Private LLM and the Data Classification Module by identifying incorrect results or actions and integrating feedback from system interactions. Through this process, it teaches Private LLM, enhancing its learning capacity, accuracy, and robustness over time. It also improves the Data Classification Module's ability to adjust its processes, enabling more effective handling of future data classifications and routing. The module leverages insights from Public LLMs and other private models to align with broader patterns while maintaining security and confidentiality. By detecting gaps and misclassifications, it enables real-time adjustments, ensuring continuous optimization and enhanced system performance across multiple modules.

### Alternative Embodiments and Potential Variations

This system can be implemented with various data classification techniques such as rule-based algorithms or machine learning models. The adaptive routing can be modified to incorporate additional criteria, such as real-time risk assessments or user preferences. Alternative embodiments may involve different types of abstraction methods, including encryption or tokenization, to ensure data security. Routing can also adapt to specific application needs, such as using conditional pathways for certain query types or integrating with additional data sources for enriched responses. Various levels of data abstraction can be applied depending on the sensitivity and intended use of the data. The invention supports multiple embodiments to address diverse operational requirements while maintaining core confidentiality principles.

1. A system for adaptive multi-LLM interaction comprising a data classification module configured to assess data sensitivity and determine routing for data queries; a confidentiality management process that includes data abstraction for public LLM interactions; an abstraction layer for generalizing sensitive information; an adaptive routing framework allowing flexible query processing through multiple LLMs based on data classification and group policies; and a feedback and error handling mechanism to improve classification and routing accuracy over time.

2. The system of claim 1, wherein the adaptive routing supports real-time adjustments using integrated feedback and error handling mechanisms, enabling sequential, parallel, or conditional processing of data based on predefined criteria.

3. The system of claim 1, further comprising a feedback mechanism to improve classification and routing accuracy over time, enabling continuous learning and adaptation of the AI models based on new information.

4. The system of claim 1, wherein the feedback mechanism incorporates user inputs and learned corrections to further teach the AI models, enhancing adaptive routing and classification accuracy over time.
